(19) United States
(12) Patent Application Publication
(10) Pub. No.: US 2009/0223946 A1
(43) Pub. Date: Sep. 10, 2009

(54) COMB POWERING CONDUCTORS BASED FLEXIBLE THERMAL RADIATOR

(76) Inventor: Ravindra Wijesiriwardana, Bentonville, AR (US)

Correspondence Address: RAVINDRA WIJESIRIWARDANA, 2001 LATROBE DRIVE APT 20, BENTONVILLE, AR, 72712, US

(21) Appl. No.: 12/395,785

(22) Filed: Mar. 2, 2009

Related U.S. Application Data
(60) Provisional application No. 61/033,655, filed on Mar. 4, 2008.

(51) Int. Cl. H05B 3/34; H05B 3/02

(52) U.S. Cl. 219/529; 219/539

(57) ABSTRACT

A flexible thermal radiator made by using two comb powering conductors to power the electrical heating element. The electrical current passes from one powering conductor to the other through the electrical heating element. The comb powering conductors provide an even distribution of currents throughout the structure and hence maintain a uniform current density that results in uniform temperature distribution of the structure avoiding hot-spots.

### CROSS-REFERENCE TO RELATED APPLICATIONS

This application claims the benefit of provisional patent application Ser. No. 61/033,655, filed Mar. 4, 2008 by the present inventor.

### FEDERALLY SPONSORED RESEARCH

Not Applicable

### SEQUENCE LISTING OR PROGRAM

Not Applicable

### BACKGROUND

1. Field

This application relates to a flexible heater that converts electrical energy into thermal energy.

2. Prior Art

Many methods are used for manufacturer electrically heated flexible heaters. These flexible heaters convert the electrical energy into thermal energy by the flow of an electrical current through an electrically conductive heating element. The electrically conductive heating element is connected to an electrical power source via two powering conductors. The first uses of the flexible electrically conductive heating elements were reported in the 19^{th} century. There are many methods of constructing a physically flexible electrically conductive heating element. The major constructions can be divided into two categories depending on the distribution of the electrically conductive materials in the electrically conductive heating element. The first method is the use of individual or any combination of electrically conductive wires, fibers, yarns, flexible tapes, etching, electrically conductive material depositing and electrically conductive ink printing in an area pattern integrated into flexible substrates. The U.S. Pat. No. 1,708,875 describes the use of electrically conductive wires to form an electrically conductive heating element in a therapeutic blanket. The second category is the use plane continuous homogeneous electrically conductive medium as the heating element. Thin or thick electrically foils, etching, electrically conductive material depositing methods, electrically conductive ink printing, are used for the various constructions.

The flexible thermal heaters or radiators (FTRs) constructed according to above methods and processes have limitations. This is due to the uneven distribution of the electrical currents in the heater that develops heat concentration regions or hot-spots in the heating zone. This results in degradation of the performance, lower the lifetime of the heater and ultimately leads to malfunctioning due to burnt off of the electrical current path. In addition, due to the variation of electrical resistance of the flexible electrically conductive heating element and the variation of electrical resistance of the powering conductors, an uneven distribution of temperature and variation of temperature are developed with time in the heating zone, that are not desirable in most of the applications. In addition due to the uneven current distributions of these heaters, the power conversion efficiency from electrical to thermal and the reliability of the heater gets lower.

Therefore the objectives of the present invention are, to provide a better performing flexible thermal radiator having an even temperature distribution avoiding hot-spots, a better power converting efficiency, a better thermal distribution under deformation of the heater and more reliability.

### SUMMARY OF THE INVENTION

The comb powering conductors based flexible thermal radiator consists of two comb powering conductors electrically connected via the electrically conductive heating element.

The FTR consist of three parts (FIG. 1A FIG. 1B FIG. 1C FIG. 1D). The first part consists of the comb powering conductors. This part can be constructed with weaving, knitting (weft knitting or warp knitting) nonwoven, conductive ink printing, flexible conductive tape, plasma deposition, etching methods.

The comb powering conductors (001) were constructed on a flexible substrate (002), or integrated into a flexible substrate (002) or without a substrate (002). This substrate (002) may be a polymer based, fabric or any other flexible material based.

The second part (003) is the action zone or the flexible radiator and it is constructed by using flexible conductive materials. This is constructed by using an electrically conductive particles filled flexible material such as electro-conductive resin. These two parts were joined by using curing processes, mechanical bonding processes including molding, fastening together by using conductive paste, Thermal bonding process or chemical bonding process. So the powering conductors are embedded in the heating material (FIG. 1C). This was done to avoid any pressure contact between the powering conductors and the heating element, as it will results in variation of electrical resistance with deformation.

The third part is constructed with flexible materials with specific thermal properties depending on an application. This part (005) is constructed on top of the flexible thermal radiator (004). The purposes of the third part (005) of the comb powering conductors based flexible thermal radiator include, improving the performance (efficiency and safety) and providing the electrical and thermal insulation. This part (005) is constructed by using flexible materials. One aspect of this part (005) would be to retain heat and in such applications flexible materials having higher heat capacities are used. Another aspect of this part (005) would be transmit thermal energy and in such applications flexible materials with low heat capacities are used.

Then comb powering conductors based flexible thermal radiator can be sandwiched between flexible, inflexible, fabric, non fabric layers. In addition the surface can be shaped to suit any cavity or pattern or shape to suit a particular application.

### DRAWINGS

FIG. 1A—Electro conductive material paths of the comb powering conductors.

FIG. 1B—Comb powering conductors and the substrate.

FIG. 1C—Three dimensional view of the Flexible thermal radiator with the electro-conductive heating material.

FIG. 1D—Flexible thermal radiator with additional layers.

FIG. 2—Time response of the normalized temperature of the flexible thermal radiator.

FIG. 3—Normalized surface temperature distribution of the flexible thermal radiator.

001—Comb powering conductor pair.

002—Substrate.

003—Electro conductive flexible heating material.

004—Flexible thermal radiator comprises of comb powering conductors and electro conductive flexible heating materials.

005—Layer of specific thermal properties.

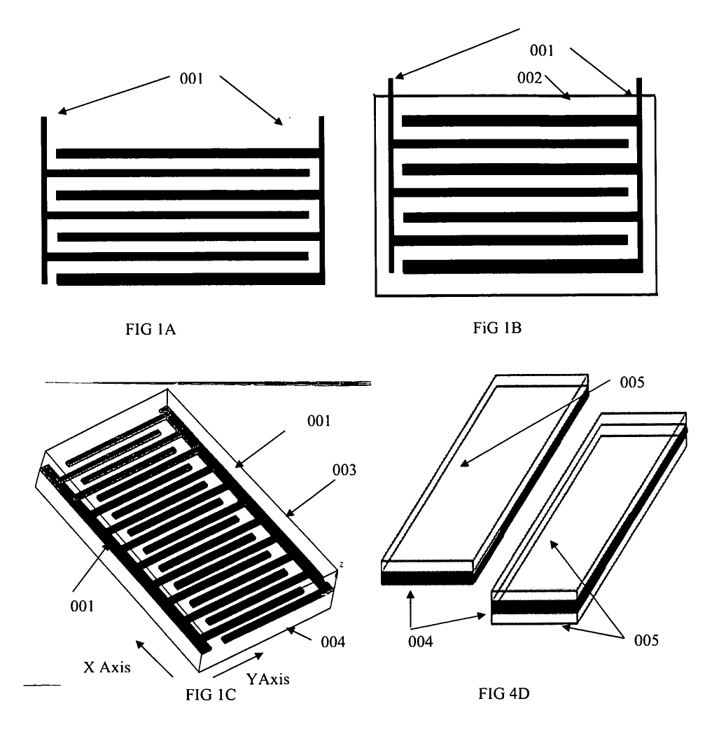

### DETAILED DESCRIPTIONS OF FIG. 1A, FIG. 1B, FIG. 1C and FIG. 1D

FIG. 1A shows the two dimensional arrangement of the electro conductive path of the comb powering conductors that powering the flexible electrically conductive heating element (003). These comb powering conductors can be manufactured by using flexible electro-conductive materials such as metallic foil, electro conductive fabric, electro conductive polymer and electro conductive ink. The powering conductor patterns can be constructed by using etching, cutting, weaving, knitting, material deposition or printing. The two ends of the powering conductors are connected to electrical power source. The electrical power source is either alternative electrical (AC) power source or direct electrical (DC) power source.

FIG. 1B shows the comb powering conductors (001) and the substrate material (002). This substrate is constructed with flexible electro-conductive or electrically insulating materials. The corn powering conductors are constructed on this substrate material or in the same layer of the substrate material.

FIG. 1C shows the electrically conductive flexible thermal radiator (004). The electrically conductive heating material matrix (003) is electrically connected to the comb powering conductors.

FIG. 1D shows the additional layers (005) of the embodiment. These layers can be on a one side of the electrically conductive flexible thermal radiator (004) or either side of the electrically conductive flexible thermal radiator (004).

Operation of the Flexible Thermal Radiator

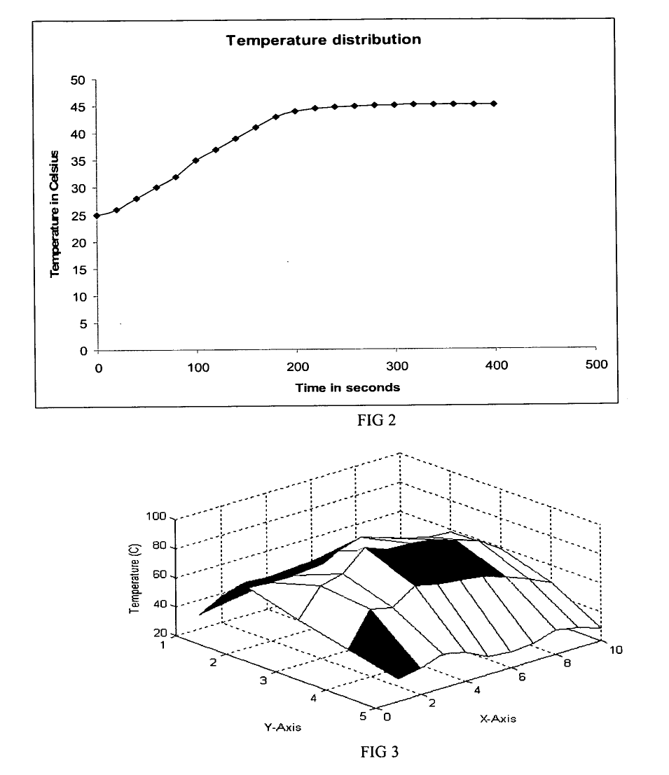

The two comb powering conductors are connected to an electrical power source. The electrical current flows from one powering conductor to the other through the electrically conductive heating material matrix (003). The current is evenly spread through the structure due to the comb powering conductor arrangement and hence a uniform current density is maintained thorough the structure of the heater. Therefore this flexible thermal radiator (004) is capable of providing a uniform temperature distribution in the structure. The time response of the flexible thermal radiator (004) is shown on the FIG. 2. The surface temperature distribution of the flexible thermal radiator (004) is shown in FIG. 3.

I claim:

1.0 A flexible electrical heater comprises of two comb powering conductors made from flexible or non flexible electrically conductive materials and electrical heating element made from flexible or non flexible electrical conducting materials, such that the electrical current passes from one powering conductor to the other through the electrically conductive heating element.

2.0 A device according to claim 1 having more than two comb powering conductors.

3.0 A device according to the claim 1 having at least one thermal conductive polymer matrix layer on the device.

4.0 A device according to claim 1 or claim 2 having at least one electrically insulating layer on the device.

5.0 A device or devices constructed according to the claims 1 to 4 either integrated in or integrated onto or mechanically, chemically, thermally attached to a garment jacket, strap, glove and heater pad, fabric or blanket.

6.0 Use of a device constructed according to claims 1 to 4 in under water diving suites and vehicle seats.

7.0 A device according to claims 1 to 4 manufactured by using textiles manufacturing process such as weaving, knitting, nonwoven methods or any combination of these three methods.

8.0 The heating element material in claim 1 is made of meal particles loaded or carbon loaded flexible polymer material.

9.0 Use of a device according to claims 1 to 4 to heat up human body parts such as limbs and joints.

10.0 A device according to claim 1 or claim 2 manufactured with any shape to suite an application.
